(19) United States
(12) Patent Application Publication
(10) Pub. No.: US 2025/0267629 A1
(43) Pub. Date: Aug. 21, 2025

(54) APPLICATION OF ALLOCATING WIRELESS LINKS OF ACCESS POINT MULTI-LINK DEVICE FOR WIRELESS STATIONS

(71) Applicant: MEDIATEK INC., Hsinchu City (TW)

(72) Inventors: Kai-Hsiang HSIEH, Hsinchu City (TW); Chih-Kun CHANG, Hsinchu City (TW); Chien-Chih CHEN, Hsinchu City (TW)

(21) Appl. No.: 18/815,958

(22) Filed: Aug. 27, 2024

Related U.S. Application Data
(60) Provisional application No. 63/555,923, filed on Feb. 21, 2024.

(51) Int. Cl. H04W 72/044; H04W 76/15; H04W 88/08

(52) U.S. Cl. CPC H04W 72/044; H04W 76/15; H04W 88/08

(57) ABSTRACT

In an aspect of the disclosure, a method for allocating wireless links of an access point (AP) multi-link device (MLD) is provided. The method comprises: establishing connections with stations correspondingly via wireless links; receiving a signal strength indication of each station on each wireless link; obtaining a weight on each wireless link according to the signal strength indication, a packet error rate, a channel idle ratio and a channel usage status; allocating each wireless link for each station based on the weight of each wireless link; and notifying each station respectively with an allocated wireless link from wireless links via an initial control frame.

This application claims the benefit of U.S. provisional application Ser. No. 63/555,923, filed Feb. 21, 2024, the subject matter of which is incorporated herein by reference.

### TECHNICAL FIELD

The disclosure relates in general to wireless communication devices, and more particularly, to techniques of methods and apparatuses about schemes to have an application of allocating wireless links of access point (AP) multi-link device (MLD) for wireless stations.

### BACKGROUND

Access point (AP) or non-access point (non-AP) multi-link device (MLD) can support multi-links with different bands (e.g., 2G, 5G or 6G), such as Wi-Fi 7 (802.11be) Multi-link operation (MLO) performed on a Wi-Fi 7 MLD. However, when more than one MLO devices (each including at least two stations (STAs)) is/are connected, CSMA/CA (Carrier-sense multiple access with collision avoidance) must be performed for contending and only one set of data transmission can occur at a time unless OFDMA (Orthogonal Frequency-Division Multiple Access) or Spatial reuse (SR) is available. Also, in the case of the AP device performing MLO with legacy device(s) (only available for connecting to MLD via single radio link), when legacy device(s)/station(s) (STAs) and STAs of non-AP MLO EMLSR (enhanced Multi-Link-Single-Radio) device(s) connect to the same MLO AP or AP MLD, the non-AP MLO EMLSR device(s) are also arranged on the same link of the AP MLD, due to the legacy device(s)/STAs only stay on a fixed link of the AP MLD. In the meantime, other links of the AP MLD are idle, and legacy device(s)/STAs and STAs of non-AP MLO EMLSR device(s) are competing on the same link, which causes network congestion. Thus, there are needs for allocating wireless links of AP MLD for wireless device(s)/STAs including legacy device(s)/STAs and non-AP MLO EMLSR device(s).

### SUMMARY

The present disclosure describes techniques for allocating wireless links of AP MLD for wireless stations.

The first aspect of the present disclosure features a method for allocating one or more wireless links of an access point (AP) multi-link device (MLD). The method comprises establishing, by the AP MLD, one or more connections with one or more stations correspondingly via the one or more wireless links. The method also comprises receiving, by the AP MLD, a signal strength indication of each of the one or more stations on each of the one or more wireless links. The method also comprises obtaining, by the AP MLD, a weight on each of the one or more wireless links according to the signal strength indication, a packet error rate, a channel idle ratio and a channel usage status. The method also comprises allocating, by the AP MLD, each of the one or more wireless links for each of the one or more stations, based on the weight of each of the one or more wireless links. The method also comprises notifying, by the AP MLD, each of the one or more stations respectively with an allocated wireless link from the one or more wireless links via an initial control frame.

The second aspect of the present disclosure features an apparatus for wireless communication. The apparatus is an AP MLD. The apparatus comprises at least one processor and a plurality of wireless links. The at least one processor of the AP MLD is configured to perform operations. The operations comprise establishing one or more connections with one or more stations correspondingly via one or more wireless links of the plurality of wireless links. The operations also comprise receiving a signal strength indication of each of the one or more stations on each of the one or more wireless links. The operations also comprise obtaining a weight on each of the one or more wireless links according to the signal strength indication, a packet error rate, a channel idle ratio and a channel usage status. The operations also comprise allocating, by the AP MLD, each of the one or more wireless links for each of the one or more stations, based on the weight of each of the one or more wireless links. The operations also comprise notifying each of the one or more stations respectively with an allocated wireless link from the one or more wireless links via an initial control frame.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1A is a block diagram illustrating an example wireless communication system, according to some implementations of the present application.

FIG. 1B is a diagram illustrating random allocation of wireless links of the AP MLD for Non-AP MLDs and a legacy station, according to some implementations of the present application.

FIG. 1C is a diagram illustrating smart allocation of wireless links of the AP MLD for Non-AP MLDs and the legacy station, according to some implementations of the present application.

FIG. 2 is a diagram illustrating an example procedure for allocating wireless links between the AP MLD, and non-AP MLDs and the legacy station, according to some implementations of the present application.

FIG. 3 is a diagram illustrating a comparison between conventional mean and improvement mean for allocating wireless links of AP MLD, according to some implementations of the present application.

FIG. 4 is a flowchart of a method (process) for allocating wireless links of AP MLD, according to some implementations of the present application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

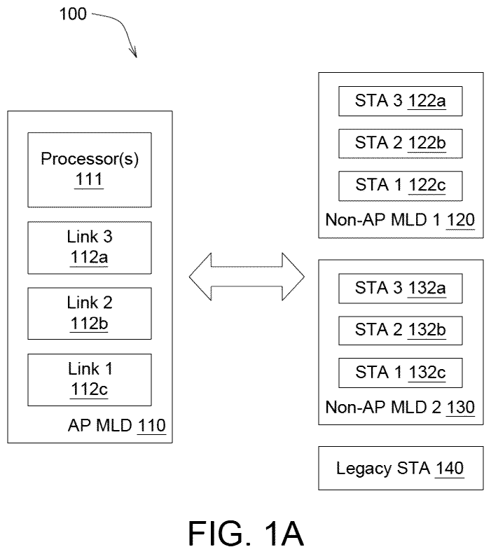

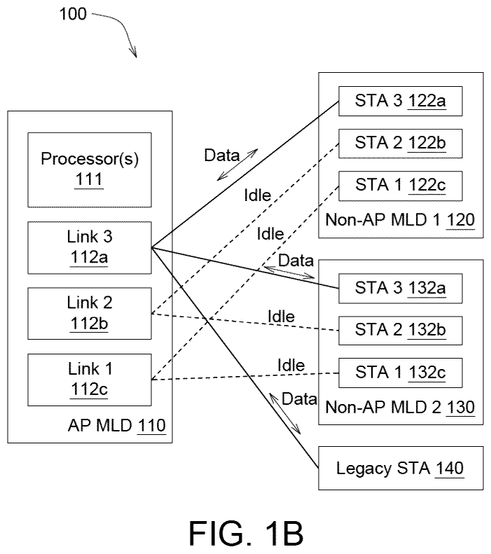

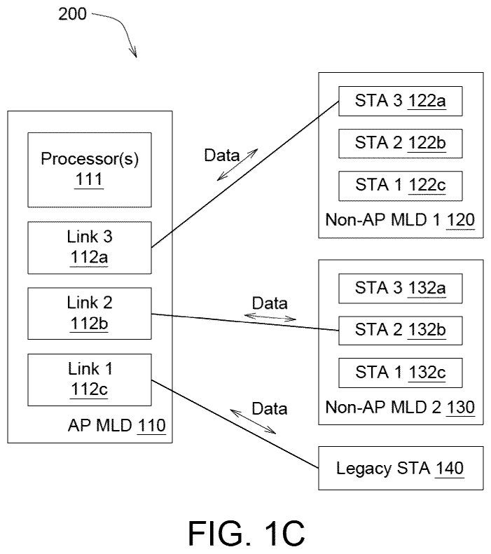

FIG. 1A is a block diagram illustrating an example wireless communication system 100, according to some implementations of the present application. A device enabling to perform MLO can be referred as an AP MLD 110, as shown in FIG. 1, which the AP MLD 110 may include at least one processor 111 and multiple links, link 3 112a, link 2 112b and link 1 112c. The number of the links of the AP MLD 110 can be varied based on the specification of the AP MLD 110. In this example, the 3 links of the AP MLD 110 represent different channel to access different access point wirelessly with different radio frequency. For example, the link 3 112a supports a 6G AP channel with 320 MHz bandwidth (BW), the link 2 112b supports a 5G AP channel with 160 MHz BW, and the link 1 112c supports a 2G AP channel with 20 MHz BW.

The example wireless communication system 100 can also comprise multiple non-AP devices for wirelessly connecting to the AP MLD 110 to enable data transmission between the AP MLD 110 and the non-AP devices. As the example of FIG. 1, the non-AP devices include non-AP MLD 1 120, non-AP MLD 2 130 and legacy station (STA) 140.

In some implementations, the non-AP MLD 1 120 includes STA 3 112a, STA 2 112b and STA 1 112c. In this example, the 3 STAs of the non-AP MLD 1 120 represent different channel to wirelessly access different links of the AP MLD 110 with different radio frequency. For example, the STA 3 122a supports the 6G AP channel with 320 MHz bandwidth (BW), the STA 2 122b supports the 5G AP channel with 160 MHz BW, and the STA 3 122c supports the 2G AP channel with 20 MHz BW. The non-AP MLD 2 130.

Similarly, the non-AP MLD 2 130 includes STA 3 132a, STA 2 132b and STA 1 132c. In this example, the 3 STAs of the non-AP MLD 2 130 represent different channel to wirelessly access different links of the AP MLD 110 with different radio frequency. For example, the STA 3 132a supports the 6G AP channel with 320 MHz bandwidth (BW), the STA 2 132b supports the 5G AP channel with 160 MHz BW, and the STA 3 132c supports the 2G AP channel with 20 MHz BW.

The legacy STA 140 is also referred with a wireless communication device which is only available for connecting to MLD via single radio channel, which may supports the 6G AP channel with 320 MHz bandwidth (BW), the 5G AP channel with 160 MHz BW or the 2G AP channel with 20 MHz BW, respectively corresponding to the link 3 112a, link 2 112b and link 1 112c of the AP MLD 110. The initial connecting status between the AP MLD 110 and the non-AP MLD 1 120, the non-AP MLD 2 130 and the legacy STA 140 will be described referring to FIG. 1B as following.

FIG. 1B is a diagram illustrating random allocation (or initial connecting status) of wireless links of the AP MLD 110 for the non-AP MLD 1 120, the non-AP MLD 2 130 and the legacy STA 140, according to some implementations of the present application. As shown in FIG. 1B, in the initial connecting status, the legacy STA 140 and EMLSR Stations, non-AP MLD 1 120 and the non-AP MLD 2 130, are on the same channel, link 3 112a of the AP MLD 110, and, in the meantime, other links, link 2 112b and link 1 112c are idle while the data transmission on link 3 112a is busy.

In this case, as when using Hybrid MLO devices (e.g., EMLSR, such as STAs of non-AP MLD 1 120 and non-AP MLD 2 130) and legacy devices (such as the legacy STA 140) connecting to MLO AP (such as links of AP MLD 110), the AP MLD 110 will allocate wireless links, link 3 112a, link 2 112b and link 1 112c, for wireless STAs, STAs of non-AP MLD 1 120 and non-AP MLD 2 130 and the legacy STA 140. When the AP MLD 110 determines that more than one non-AP devices, non-AP MLD 1 120, non-AP MLD 2 130 and the legacy STA 140, are connected, the AP MLD 110 may obtain information of each connected device. The information may include the type of each connected device, and which links each connected device supports. For example, the AP MLD 110 may obtain the information of each connected device for identifying the connected devices including the legacy station 140 and the STAS of non-AP MLD 1 120 and non-AP MLD 2 130, and identifying links that the STAs supports, such as the 2G, 5G or 6G AP channels as discussed above.

In some implementations, the information also includes RSSI (received Signal Strength Indicator) of the connected devices. The processor 111 of the AP MLD 110 may firstly obtain weight (WT) on each link, such as the link 3 112a, the link 2 112b and the link 1 112c, based on RSSI of the connected device, for allocating each link for the connected devices, such as the legacy station 140 and the STAS of non-AP MLD 1 120 and non-AP MLD 2 130. For example, if the absolute value of RSSI (|RSSI|) of the connected devices (corresponding to each supported STAs of each devices) via a specified link, such as link 3 112a which may connected to the STA 3 122a of the non-AP MLD 1 120, the STA 3 132a of the non-AP MLD 2 120 and the legacy STA 140, is smaller than the absolute value of link range (can be also referred as the maximum linkage ability) RSSI (|Link Rang RSSI|), the weight can be set as zero (WT=0), which means the specified STA of connected device is not available for the specified link of the AP MLD 110. If the absolute value of the RSSI is not smaller than absolute value of the link range RSSI, the WT may set as 100−25*(|RSSI|/70).

In some implementations, the information also includes packet error rate (PER) of the connected devices. The processor 111 of the AP MLD 110 may secondly obtain weight (WT) on each link, such as the link 3 112a, the link 2 112b and the link 1 112c, based on PER between each link and STAs of the connected devices, for allocating each link for the connected devices, such as the legacy station 140 and the STAS of non-AP MLD 1 120 and non-AP MLD 2 130. For example, if the weight is not set as zero due to the RSSI information, the weight may be then minus PER*25 (WT−PER*25, if WT is not 0).

In some implementations, the information also includes channel (Ch) idle ratio on each link of the AP MLD 110. The processor 111 of the AP MLD 110 may thirdly obtain weight (WT) on each link, such as the link 3 112a, the link 2 112b and the link 1 112c, based on the Ch idle ration on each link of the AP MLD 110, for allocating each link for the connected devices, such as the legacy station 140 and the STAS of non-AP MLD 1 120 and non-AP MLD 2 130. For example, if the weight is not set as zero due to the former information, RSSI and PER, the weight may be then minus 25 and add Ch idle ratio*25 (WT−25+Ch idle ratio*25, if WT is not 0).

In some implementations, the information also includes the ratio between the number of connected STAs on each link of the AP MLD 110 and the number of max support devices of the same link of the AP MLD 110. The processor 111 of the AP MLD 110 may fourthly obtain weight (WT) on each link, such as the link 3 112a, the link 2 112b and the link 1 112c, based on the ratio of each link of the AP MLD 110, for allocating each link for the connected devices, such as the legacy station 140 and the STAS of non-AP MLD 1 120 and non-AP MLD 2 130. For example, if the weight is not set as zero due to the former information, RSSI, PER and Ch idle ratio, the weight may be then set as 25 multiplexing the ratio (WT=25*(the number of connected STAs on this link/the number of max support devices on the same link), if WT is not 0). Consequently, the obtained weight of each link of the AP MLD 110 corresponding to STAs of the connected device, can be used for allocating (or reallocating) STAs of connected devices, and then the AP MLD 110 may notify the STAs of the connected device respectively with the allocated wireless link, such as link 3 112a, link 2 112b or link 1 112c, via an initial control frame. The connecting status after reallocating (or smart allocating) between the AP MLD 110 and the non-AP MLD 1 120, the non-AP MLD 2 130 and the legacy STA 140 will be described referring to FIG. 1C as following.

FIG. 1C is a diagram illustrating smart allocation of wireless links of the AP MLD for non-AP MLDs and the legacy station, according to some implementations of the present application. As shown in FIG. 1C, after the relocating, the data transmission between the AP MLD 110 and non-AP MLD 120 is allocated on link 3 112a of the AP MLD 110 and STA 3 122a of the non-AP MLD 120, based on the weight on link 3 112a of the AP MLD 110 corresponding to STA 3 122a of non-AP MLD 1 120, STA 3 132a of non-AP MLD 2 130 or the legacy STA 140 (if support). In this case, the weight on link 3 112a of the AP MLD 110 corresponding to STA 3 122a of non-AP MLD 1 120 is greater than the weight corresponding to STA 3 132a of non-AP MLD 2 130 or the legacy STA 140, thus link 3 112a of the AP MLD 110 is allocated for STA 3 122a of the non-AP MLD 1 120. Similarly, the weight on link 2 112b of the AP MLD 110 corresponding to STA 2 132b of non-AP MLD 2 130 is greater than the weight corresponding to the legacy STA 140, thus link 2 112b of the AP MLD 110 is allocated for STA 2 132a of the non-AP MLD 2 130, and link 3 112c of the AP MLD 110 is allocated for the legacy STA 140.

In some implementations, upon the process 111 of the AP MLD 110 determining that the connected device or STAs including legacy station (only available for connecting to MLD via single radio link, such as the legacy STA 140), an individual wireless link, which is not used or connected by other stations for data transmission, may be allocated, by for the legacy station, such as the link 3 112c of the AP MLD 110 is allocated for the legacy STA 140, as shown by the example of FIG. 1C. By this means, the competition between legacy stations and MLO devices on the same link of AP MLD can be avoid.

In some implementations, wherein upon the process 111 of the AP MLD 110 determining that the connected device or STAs including the non-AP MLD, one or two wireless links of the one or more wireless links are allocated, by the AP MLD, for the non-AP MLD including 3 channels (or stations), such as only one link (link 3 112a or link 2 112b) of the AP MLD 110 is respectively allocated for STA 3 122a of the non-AP MLD 1 and STA 2 132b of the non-AP MLD 2, which both non-AP MLD 1 and non-AP MLD 2 have 3 support stations (channels), as shown by the example of FIG. 1C. By this means, power saving mode of the non-AP MLD(s) can be enabled for saving power consumption, since only 1 or 2 channels (or stations) of non-AP MLD is waked but not waking all channels (or stations) up.

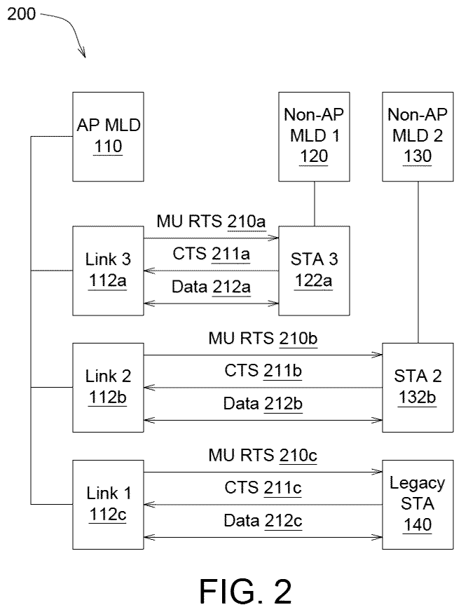

FIG. 2 is a diagram illustrating an example procedure for allocating wireless links (link 3 112a, link 2 112b and link 1 112c) between the AP MLD 110, and non-AP MLDs (non-AP MLD 1 120 and non-AP MLD 2 130) and the legacy STA 140, according to some implementations of the present application. After the smart allocation (or reallocation) discussed above, the AP MLD 110 notifies each STA of connected device respectively with an allocated wireless link via an initial control frame. For the example of FIG. 2, the initial control frame is implemented as a MU-RTS (Multi User Request to Send) 210a, 210b or 210c, which is respectively used for notifying STA 3 122a of the non-AP MLD 1 120 via the allocated link 3 112a, notifying STA 2 132b of the non-AP MLD 2 130 via the allocated link 2 112b and notifying legacy STA 140 via the allocated link 1 112c, as shown. To response the MU-RTS on the allocated link, each non-AP MLD devices and legacy stations replies a control frame via the allocated wireless link. In this case, the control frame is implemented as CTS (Clear to Send) 211a, 211b or 211c. Then, the AP MLD 110 can enable data transmission (transmit and receive packets, such as data 212a, 212b or 212c) with each connected device (non-AP MLD 1 120, non-AP MLD 2 130 or legacy STA 140) via the allocated wireless link (link 3 112a for STA 3 122a of non-AP MLD 1 120, link 2 112b for STA 2 132b of non-AP MLD 2 130 and link 1 112c for legacy STA 140). It should be noticed that, after allocating the specified wires link for the individual STA, the MLD AP 110 does not send the initial control frames (e.g. MU-RTS or BSRP (Buffer Status Report)) on all support link of the connected devices or STAs, the initial control frame is only sent on each specified wireless link to arrange each non-AP MLD to work on the specified wireless link at the same time.

In some implementations, the wireless link used for data transmission between the AP MLD and the connected devices or STAs is reallocated due to different situation, such as the PER on the specified link increases or any device is disconnected. For example, when the PER on one link of the AP MLD increases, weight on each link of the AP MLD can be updated by the means for obtaining weight as discussed above, and each link can be than reallocated for the connected devices or STAs according to the updated weight of each link of the AP MLD corresponding to different STAs. For another example, when one or more devices or STAs is/are disconnected, weight on each link of the AP MLD can also be updated by the means for obtaining weight as discussed above, and each link can be than reallocated for the connected devices or STAs according to the updated weight of each link of the AP MLD corresponding to different STAs.

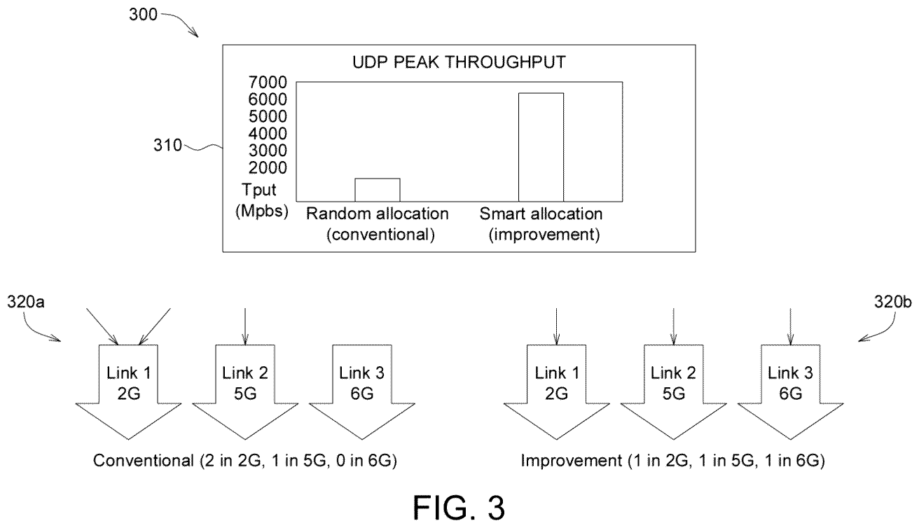

FIG. 3 is a diagram illustrating a comparison 300 between conventional mean 320a and improvement mean 320b for allocating wireless links of AP MLD, according to some implementations of the present application. As shown in graph 310 of FIG. 3, after the reallocation (smart allocation, improvement mean 320b), comparing to conventional random allocation (conventional mean 320a), all non-AP MLD EMLSR devices could work on different links at the same time (as shown by improvement mean 320b, 1 in 2G, 1 in 5G and 1 in 6G), it will decrease ⅔ the latency and increase almost 5-times performance (such as UDP Peak Throughput in graph 310).

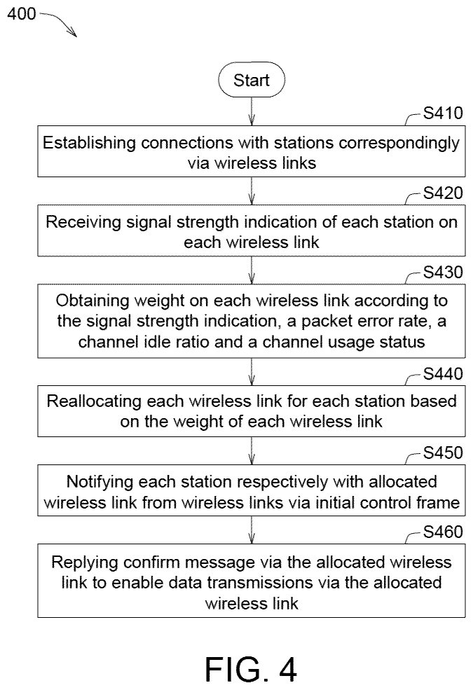

FIG. 4 is a flowchart of a method (process 400) for allocating wireless links of AP MLD, according to some implementations of the present application. In step S410, connections with stations are established correspondingly via wireless links, such as connections with non-AP MLD 1 120, non-AP MLD 2 130 and legacy STA 140 are established correspondingly via wireless link 3 112a, link 2, 112b and link 1 112c of the AP MLD 110 as shown in FIG. 1B. In step S420, the AP MLD receives a signal strength indication (such as RSSI) of each of the one or more stations on each of the one or more wireless links. In step S430, the APMLD obtains a weight (WT) on each wireless link according to the signal strength indication, a packet error rate (PER), a channel idle ratio and a channel usage status. In step S440, the AP MLD allocates each wireless link for each station, based on the weight of each wireless link, such as the AP MLD 110 allocates wireless link 3 112a, link 2, 112b and link 1 112c respectively for the STA 3 122a of non-AP MLD 1 120, STA 2 132b of non-AP MLD 2 130 and legacy STA 140 as shown in FIG. 1C. In step S450, the AP MLD notifies each station respectively with allocated wireless link from wireless links via initial control frame, such as the AP MLD 110 notifies the STA 3 122a of non-AP MLD 1 120, STA 2 132b of non-AP MLD 2 130 and legacy STA 140 with allocated wireless link 3 112a, link 2, 112b and link 1 112c via initial control frames, MU RTS 210a, 210b, and 210c, respectively, as shown in FIG. 2. In step S460, the connected devices/STAs which received the initial control frame, reply control frame via the allocated wireless link to enable data transmissions via the allocated wireless link, such as non-AP MLD 1 120, non-AP MLD 2 130 and legacy STA 140 reply control frames, CTS 211a, 211b and 211c, via allocated link 3 112a, link 2, 112b and link 1 112c of the AP MLD 110 respectively, to enable data transmissions, data 212a, 212b and 212c, via allocated link 3 112a, link 2, 112b and link 1 112c of the AP MLD 110, as shown in FIG. 2.

In certain configurations, at least one processor of the AP MLD establishing the one or more connections with one or more stations comprises identifying the one or more stations including a legacy station or a non-access point (non-AP) multi-link device (MLD).

In certain configurations, upon the at least one processor of the AP MLD determining that the one or more stations including the legacy station, an individual wireless link of the one or more wireless links is allocated for the legacy station, which the individual wireless link is not connected by other stations.

In certain configurations, upon the at least one processor of the AP MLD determining that the one or more stations including the non-AP MLD, one or two wireless links of the one or more wireless links are allocated for the non-AP MLD including 3 channels, to enable a power saving mode of the non-AP MLD.

In certain configurations, upon the at least one processor of the AP MLD determining that the packet error rate on one of the one or more links increases, the weight on each of the one or more wireless links is updated and each of the one or more wireless links is reallocated for each of the one or more stations according to a updated weight of each of the one or more wireless links.

In certain configurations, upon the at least one processor of the AP MLD determining that one of the one or more stations is disconnected, the weight on each of the one or more wireless links is updated and each of the one or more wireless links is reallocated for connected stations according to a updated weight of each of the one or more wireless links.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for allocating one or more wireless links of an access point (AP) multi-link device (MLD), comprising:
establishing, by the AP MLD, one or more connections with one or more stations correspondingly via the one or more wireless links;
receiving, by the AP MLD, a signal strength indication of each of the one or more stations on each of the one or more wireless links;
obtaining, by the AP MLD, a weight on each of the one or more wireless links according to the signal strength indication, a packet error rate, a channel idle ratio and a channel usage status;
allocating, by the AP MLD, each of the one or more wireless links for each of the one or more stations, based on the weight of each of the one or more wireless links; and
notifying, by the AP MLD, each of the one or more stations respectively with an allocated wireless link from the one or more wireless links via an initial control frame.

2. The method of claim 1, wherein establishing the one or more connections with one or more stations comprises identifying the one or more stations including a legacy station or a non-access point (non-AP) multi-link device (MLD).

3. The method of claim 2, wherein upon determining that the one or more stations including the legacy station, an individual wireless link of the one or more wireless links is allocated, by the AP MLD, for the legacy station, wherein the individual wireless link is not connected by other stations.

4. The method of claim 2, wherein upon determining that the one or more stations including the non-AP MLD, one or two wireless links of the one or more wireless links are allocated, by the AP MLD, for the non-AP MLD including 3 channels, to enable a power saving mode of the non-AP MLD.

5. The method of claim 1, further comprising replying, by each of the one or more stations, a control frame via the allocated wireless link, to enable data transmissions between the AP MLD and each of the one or more stations via the allocated wireless link,
wherein the initial control frame is a Multi User Request to Send (MU-RTS), and the control frame is a Clear to Send (CTS).

6. The method of claim 1, wherein upon determining that the packet error rate on one of the one or more links increases, the weight on each of the one or more wireless links is updated and each of the one or more wireless links is reallocated for each of the one or more stations according to a updated weight of each of the one or more wireless links.

7. The method of claim 1, wherein upon determining that one of the one or more stations is disconnected, the weight on each of the one or more wireless links is updated and each of the one or more wireless links is reallocated for connected stations according to a updated weight of each of the one or more wireless links.

8. An apparatus for wireless communication, the apparatus being an AP MLD, comprising:
at least one processor; and
a plurality of wireless links,
wherein the at least one processor of the AP MLD is configured to perform operations comprising:
establishing one or more connections with one or more stations correspondingly via one or more wireless links of the plurality of wireless links;
receiving a signal strength indication of each of the one or more stations on each of the one or more wireless links;
obtaining a weight on each of the one or more wireless links according to the signal strength indication, a packet error rate, a channel idle ratio and a channel usage status;
allocating, by the AP MLD, each of the one or more wireless links for each of the one or more stations, based on the weight of each of the one or more wireless links; and
notifying each of the one or more stations respectively with an allocated wireless link from the one or more wireless links via an initial control frame.

9. The apparatus of claim 8, wherein the at least one processor of the AP MLD establishing the one or more connections with one or more stations comprises identifying the one or more stations including a legacy station or a non-access point (non-AP) multi-link device (MLD).

10. The apparatus of claim 9, wherein upon the at least one processor of the AP MLD determining that the one or more stations including the legacy station, an individual wireless link of the one or more wireless links is allocated for the legacy station, wherein the individual wireless link is not connected by other stations.

11. The apparatus of claim 9, wherein upon the at least one processor of the AP MLD determining that the one or more stations including the non-AP MLD, one or two wireless links of the one or more wireless links are allocated for the non-AP MLD including 3 channels, to enable a power saving mode of the non-AP MLD.

12. The apparatus of claim 8, the at least one processor of the AP MLD is further configured to receiving a control frame from each of the one or more stations via the allocated wireless link, to enable data transmissions between the AP MLD and each of the one or more stations via the allocated wireless link,
wherein the initial control frame is a Multi User Request to Send (MU-RTS), and the control frame is a Clear to Send (CTS)

13. The apparatus of claim 8, wherein upon the at least one processor of the AP MLD determining that the packet error rate on one of the one or more links increases, the weight on each of the one or more wireless links is updated and each of the one or more wireless links is reallocated for each of the one or more stations according to a updated weight of each of the one or more wireless links.

14. The apparatus of claim 8, wherein upon the at least one processor of the AP MLD determining that one of the one or more stations is disconnected, the weight on each of the one or more wireless links is updated and each of the one or more wireless links is reallocated for connected stations according to a updated weight of each of the one or more wireless links.
